(19) United States
(12) Patent Application Publication
(10) Pub. No.: US 2002/0065917 A1
(43) Pub. Date: May 30, 2002

(54) Method for managing resources on a per user basis for UNIX based systems

(76) Inventors: Steven L. Pratt, Round Rock, TX (US); Dennis Wayne Riddlemoser, Austin, TX (US)

Correspondence Address: Duke W. Yee, Carstens, Yee & Cahoon, LLP, P.O. Box 802334, Dallas, TX, 75380, US

(21) Appl. No.: 09/726,266

(22) Filed: Nov. 30, 2000

(51) Int. Cl. G06F 15/173

(52) U.S. Cl. 709/226; 709/203

(57) ABSTRACT

A method for managing resources in a computer network based on user identity is provided. A configuration file defining specific resources is created for each network user. When a user logs in on a client computer, an attachment program matches the user identification with the user's configuration file and then attaches the resources listed within the file. When the user logs out, the program unattaches the resources, resetting the client back to its original state before login. This approach allows users to access their individual resource configurations from any client in the network.

### BACKGROUND OF THE INVENTION

1. Technical Field

The present invention relates to the allocation of resources in a computer network. More specifically, the present invention relates to allocating resources based on user identification.

2. Description of Related Art

On UNIX systems, network resources such as file systems, printers, and other peripheral devices must be attached at system initialization or later by an administrator. Optionally, the administrator may give permission to users or groups of users to manually attach certain network resources to particular client computers within the network. However, this latter approach is cumbersome and is not generally used.

Administration of network resources must be done physically on each machine from which users may need to access the resources, even if the users are remotely administered through a facility such as Network Information Services (NIS). As such, users do not have much flexibility in accessing network resources from multiple client stations.

Therefore, a method which allows central control of resource allocation for all users and permits users to access their particular resource needs from any client within the network would be desirable.

### SUMMARY OF THE INVENTION

The present invention provides a method for managing resources in a computer network based on user identity. A configuration file defining specific resources is created for each network user. When a user logs in on a client computer, an attachment program matches the user identification with the user's configuration file and then attaches the resources listed within the file. When the user logs out, the program unattaches the resources, resetting the client back to its original state before login. This approach allows users to access their individual resource configurations from any client in the network.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server in accordance with the present invention;

FIG. 3, a block diagram of a data processing system in which the present invention may be implemented is illustrated; and

FIG. 4 depicts a flowchart illustrating a method for managing network resources on a per user basis in accordance with the present invention.

### DETAILED DESCRIPTION OF THE PREFERRED EMBODIMENT

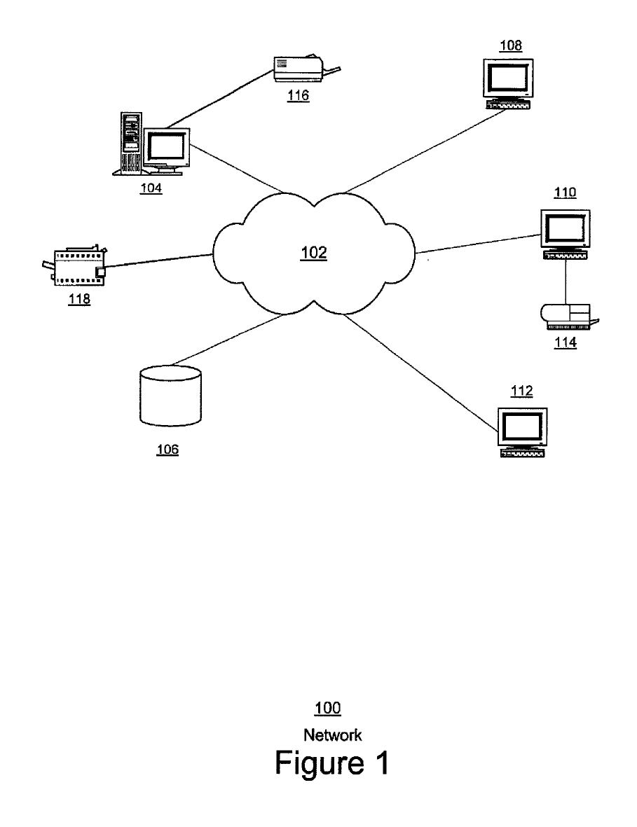

With reference now to the figures, and in particular with reference to FIG. 1, a pictorial representation of a distributed data processing system is depicted in which the present invention may be implemented.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections. In the depicted example, server 104 is connected to network 102, along with storage unit 106. In addition, clients 108, 110 and 112 are also connected to network 102. These clients, 108, 110 and 112, may be, for example, personal computers or network computers.

For purposes of this application, a network computer is any computer coupled to a network that receives a program or other application from another computer coupled to the network. In the depicted example, server 104 provides data, such as boot files, operating system images and applications, to clients 108-112. Clients 108, 110 and 112 are clients to server 104. Distributed data processing system 100 may include additional servers, clients, and other devices not shown. Distributed data processing system 100 also includes printers 114, 116 and 118. A client, such as client 110, may print directly to printer 114. Clients such as client 108 and client 112 do not have directly attached printers. These clients may print to printer 116, which is attached to server 104, or to printer 118, which is a network printer that does not require connection to a computer for printing documents. Client 110, alternatively, may print to printer 116 or printer 118, depending on the printer type and the document requirements.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 also may be implemented as a number of different types of networks such as, for example, an intranet or a local area network.

FIG. 1 is intended as an example and not as an architectural limitation for the processes of the present invention.

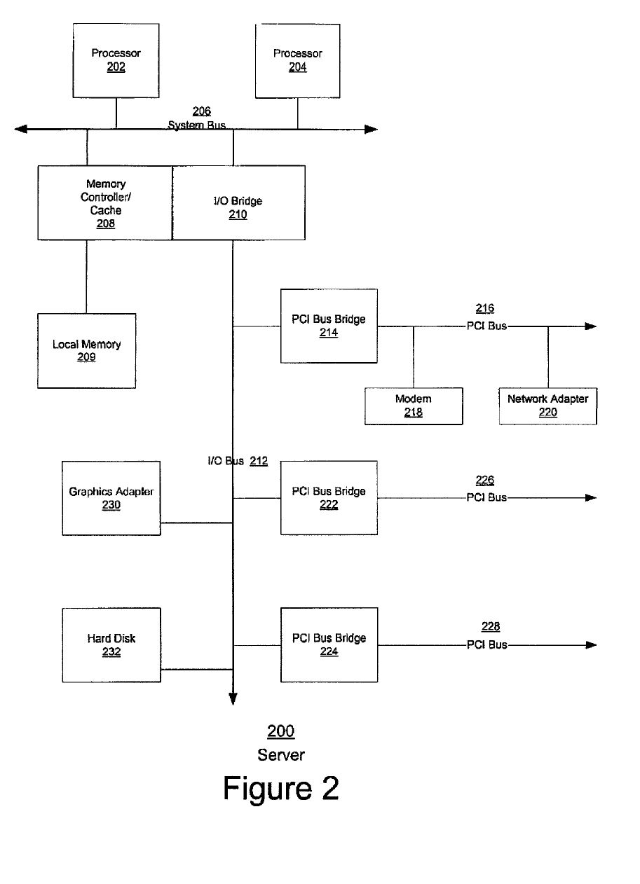

Referring to FIG. 2, a block diagram of a data processing system which may be implemented as a server, such as server 104 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RS/6000, a product of International Business Machines Corporation in Armonk, N.Y., running the UNIX operating system.

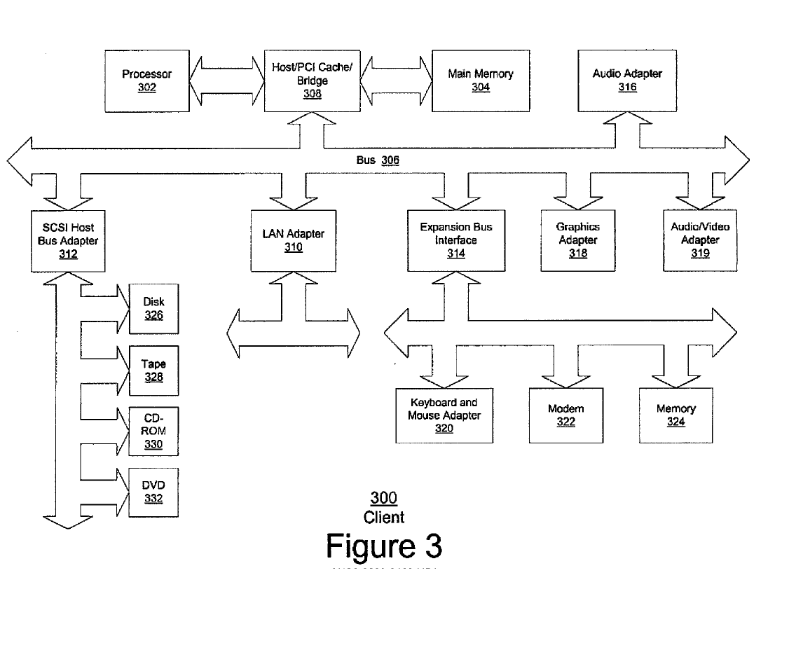

With reference now to FIG. 3, a block diagram of a data processing system in which the present invention may be implemented is illustrated. Data processing system 300 is an example of a client computer. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302.

Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as UNIX. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

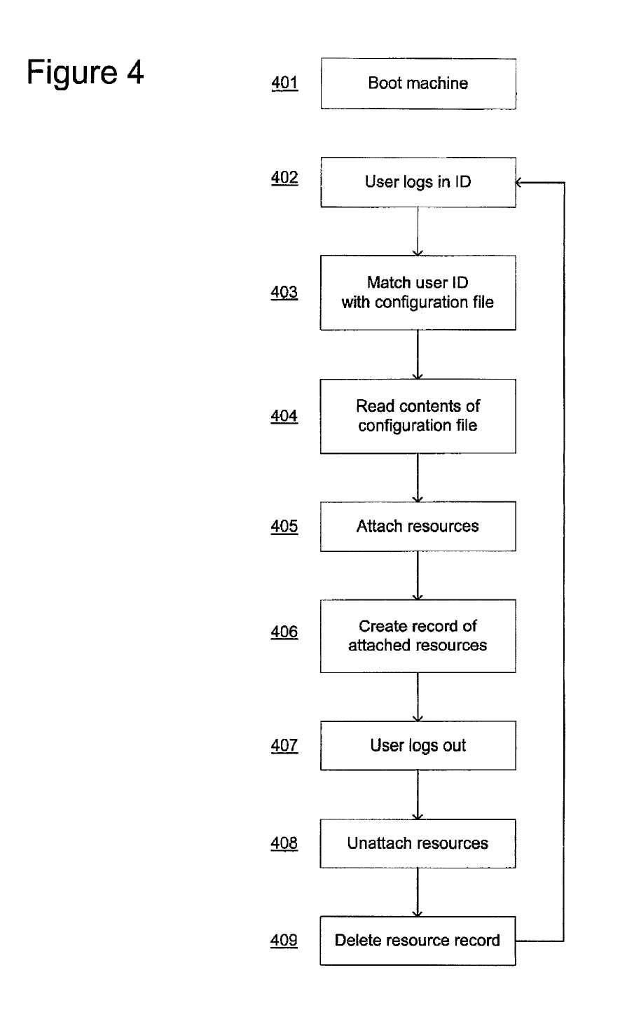

Referring now to FIG. 4, a flowchart illustrating a method for managing network resources on a per user basis is depicted in accordance with the present invention. The present invention allows users to access an individualized configuration of network resources from any client within the network, rather than limiting the configuration to one particular client.

The process begins by booting the machine (step 401). Next, a resource attachment program is initiated when a user identification is entered during login (step 402). This attachment program can be stored either on a client or a network server. The resource attachment program matches the user identity with a particular configuration file (step 403) and then reads the contents of the configuration file (step 404). The configuration file contains a list of all the network resources that a user may access. These resources can include, for example, file systems, printers, disk drives, serial devices, peripheral devices, and any other shared hardware or software. The contents of the configuration file can be set and changed by a network administrator. The configuration file is read from a well known location, such as a network server.

The resource attachment program uses the information in the configuration file to attach the authorized resources (step 405). After the individual configuration of resources has been attached to the client, the attachment program creates a record containing a list of all successfully attached resources (step 406). This attachment record allows the attachment program to keep track of which resources have been attached to the client during a particular user session, and can be stored in either the client or a network server.

When the session on the client is finished, the user simply enters a routine logout command (step 407). The resources attachment program then unattaches the resources listed in the attachment record created in step 406 (step 408). After the resources are unattached, the program deletes the contents of the attachment record (step 409), setting the client back to the original state before the user logged in at step 401.

The present invention allows for a single point of control of resource definitions for all users on a given network. This permits users to log in to any client in the network and still access their individually defined resources, independent of how that particular client has been configured, which reduces the amount of configuration required on a per machine basis. In addition, the present invention attaches only the subset of resources actually required by the user, reducing total system usage at any one time.

It should be pointed out that although the present invention has been described within the context of a UNIX based computer system, the concepts embodied in the present invention can be applied to other operating systems.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for managing resources in a computer network, comprising:
defining the contents of a configuration file for each network user;
receiving a login identification from a user;
matching the user identity with the user configuration file; and
attaching network resources to a client computer based on the user identity and the contents of the user configuration file.

2. The method according to claim 1, wherein the contents of the configuration file are defined by a network administrator.

3. The method according to claim 1, wherein the configuration file is stored on a network server.

4. The method according to claim 1, wherein the step of attaching resources to a client is accomplished by means of a resource attachment program.

5. The method according to claim 4, wherein the resource attachment program is stored on the client computer.

6. The method according to claim 4, wherein the resource attachment program is stored on a network server.

7. The method according to claim 1, wherein the step of attaching resources to a client further comprises creating a record of all successfully attached resources.

8. The method according to claim 7, wherein the record is stored on the client.

9. The method according to claim 7, wherein the record is stored on a network server.

10. The method according to claim 1, further comprising:
receiving a log out command from the user; and
unattaching the attached resources.

11. The method according to claim 7, further comprising:
receiving a log out command from the user; and
deleting the record of attached resources.

12. The method according to claim 1, wherein the client computer uses the UNIX operating system.

13. A method for accessing resources in a computer network, comprising:
logging in a user identification; and
receiving access to network resources based on an individualized configuration file.

14. A computer program product in a computer readable medium for use in a data processing system for managing resources in a computer network, the computer program product comprising:
instructions for defining the contents of a configuration file for each network user;
instructions for receiving a login identification from a user; and
instructions for matching the user identity with the user configuration file.

15. The computer program product according to claim 14, wherein the contents of the configuration file are defined by a network administrator.

16. The computer program product according to claim 14, wherein the configuration file is stored on a network server.

17. The computer program product according to claim 14, wherein the program runs on a UNIX operating system.

18. A computer program product in a computer readable medium for use in a data processing system for managing resources in a computer network, the computer program product comprising:
instructions for reading the contents of a user configuration file; and
instructions for attaching network resources to a client computer based on the user identity and the contents of the user configuration file.

19. The computer program product according to claim 18, wherein the program is stored on a client computer.

20. The computer program product according to claim 18, wherein the program is stored on a network server.

21. The computer program product according to claim 18, further comprising instructions for creating a record of all successfully attached resources.

22. The computer program product according to claim 21, wherein the record is stored on a client computer.

23. The computer program product according to claim 21, wherein the record is stored on a network server.

24. The computer program product according to claim 18, further comprising:
instructions for receiving a log out command from the user; and
instructions for unattaching the attached resources.

25. The computer program product according to claim 21, further comprising:
instructions for receiving a log out command from the user; and
instructions for deleting the record of attached resources.

26. The computer program product according to claim 18, wherein the program runs on a UNIX operating system.

27. A system for managing resources in a computer network, comprising:
means for defining the contents of a configuration file for each network user;
means for receiving a login identification from a user;
means for matching the user identity with the user configuration file; and
means for attaching network resources to a client computer based on the user identity and the contents of the user configuration file.

28. The system according to claim 27, further comprising:
means for receiving a log out command from the user; and
means for unattaching the attached resources.
